(19) United States
(12) Patent Application Publication
(10) Pub. No.: US 2026/0194728 A1
(43) Pub. Date: Jul. 9, 2026

(54) OPTICAL LENS AND CAMERA MODULE

(71) Applicant: NINGBO SUNNY OPOTECH CO., LTD, Yuyao City Ningbo, Zhejiang (CN)

(72) Inventors: Haipeng PEI, Yuyao City (CN); Yurong WU, Yuyao City (CN); Yong YANG, Yuyao City (CN); Shibei ZHU, Yuyao City (CN); Takehiko TANAKA, Yuyao City (CN)

(73) Assignee: NINGBO SUNNY OPOTECH CO., LTD, Yuyao City Ningbo, Zhejiang (CN)

(21) Appl. No.: 19/130,820

(22) PCT Filed: Nov. 17, 2023
(86) PCT No.: PCT/CN2023/132279

§ 371 Date: May 16, 2025

(30) Foreign Application Priority Data
Nov. 17, 2022 (CN) 202211458823.X
Nov. 17, 2022 (CN) 202211460285.8

(51) Int. Cl. G02B 7/02

(52) U.S. Cl. CPC G02B 7/021

(57) ABSTRACT

An optical lens assembly (1), comprising a first lens element (11), the first lens element (11) comprising a first structural portion (110) and a first optical portion (111), and the first structural portion (110) extending outwardly from the first optical portion (111); and further comprising a second lens component (20), the second lens component (20) comprising a second lens element (21) and a second lens barrel (22), wherein the second lens element (21) is mounted in the second lens barrel (22), the second lens element (21) is bonded to the second lens barrel (22) by means of adhesive provided on an outer side of the second lens element (21), and the first lens element (11) is mounted on the second lens component (20) by means of the first structural portion (110), so that when a clamping mechanism clamps the first lens element (11) for active alignment, the adjusting action is more accurate, and the efficiency of active alignment assembly is higher.

### TECHNICAL FIELD

The present application relates to the field of optical lens assemblies, and in particular to an optical lens assembly and a camera module with the same.

### BACKGROUND

Factors affecting the resolution of a camera lens come from errors of each element and its assembly, an error in the thickness of lens separating elements, an assembly fit error of the respective lens elements, variations in the refractive index of lens element materials, etc. Among them, the errors of each element and its assembly include errors of the optical surface thickness of each lens element unit, the sagittal height of the optical surface of the lens element, the surface profile of the optical surface, the radius of curvature, the eccentricity of the single surface and the inter-surface eccentricity of the lens element, the tilt of the optical surface of the lens element, etc. The magnitudes of these errors depend on mold precision and molding precision control capabilities. The error of the thickness of the lens separating element depends on the machining accuracy of the element. The assembly fit error of the respective lens elements depends on the dimensional tolerance of an assembled element and the assembly accuracy of the camera lens. The error introduced by variations in the refractive index of the lens material depends on the stability of the material and batch consistency. The error of each of the above elements affecting the resolution is accumulated and deteriorated, and the accumulated error will continue to increase with the increase of the number of lenses. The existing solution is to perform tolerance control on the size of each relatively sensitive element and compensate by the rotation of the lens element to improve the resolution. However, since the camera lens with high pixels and large aperture is more sensitive, it requires strict tolerances. For example, a lens element eccentricity of 1 μm in some sensitive camera lenses will cause 9′ image plane tilt, which makes lens element processing and assembly more and more difficult. At the same time, due to the long feedback cycle during the assembly process, the process capability index (CPK) of assembly of the camera lens is low and fluctuates greatly, resulting in a high defect rate. Moreover, as described above, because there are many factors affecting the resolution of the camera lens, which exist in a plurality of elements, the control of each factor has the limit of production accuracy. If only the accuracy of each element is improved, the improvement ability is limited and the improvement cost is high. Furthermore, it cannot meet the market's increasing demands for the imaging quality.

In general, various error factors affecting the resolution are accumulated and deteriorated, and the accumulated error will continue to increase with the increase of the number of lenses. The resolution solution of the multi-element monolithic camera lens is to control the tolerance of the size of each relatively sensitive element and use the rotation of the lens element to compensate for eccentricity to improve the resolution. The more lens elements there are, the more complicated the tolerance control and lens element matching will be. In particular, high-pixel and large-aperture camera lenses are more sensitive and require strict tolerances. In the prior art, a lens element eccentricity of 1 μm in some sensitive camera lenses will cause 12′-15′ image plane tilt, which makes lens element processing and assembly more and more difficult. At the same time, there is a long feedback cycle during the assembly process. Factors affecting the resolution of the camera lens include various links in production and manufacturing. There are also solutions in the prior art that use active alignment assembling method for optical lens assemblies to improve the optical resolution of the optical system.

In the active alignment assembly solution, the optical resolution of the optical system can be taken as the target of assembly and adjustment, and the positions of lens components of the optical lens assembly are adjusted with multiple degrees of freedom to improve the resolution. In the active alignment process, the relative positions between the lens components are adjusted and determined, and then the lens components are fixed together according to the determined relative positions, thereby manufacturing an optical lens assembly or camera module with qualified optical resolution. In this way, the optical resolution of the product can be known in advance before the camera lens is packaged, and the camera lens with qualified resolution is assembled, thereby enabling the process capability index (CPK) of the optical lens assembly or camera module in mass production to be improved. Compared with the conventional passive assembling solution, the active alignment solution of the optical lens assembly loosens the requirements for the accuracy of various elements of the lens-subassemblies or photosensitive subassemblies used to assemble the optical lens assembly or camera module and their assembly accuracy, thereby reducing the overall cost of the optical imaging lens assembly and the camera module. Therefore, the active alignment solution of the optical lens assembly can make real-time adjustments to various aberrations of the camera module during the assembly process, reduce the defect rate, reduce production costs, and improve imaging quality.

Therefore, with the increasing complexity of camera lens structures and the sensitivity of optical designs, the requirements for the assembly accuracy of the camera lens have become higher. There is an urgent need for a solution that can facilitate assembling of the camera lens and active correction of the overall aberration of the final camera lens. At the same time, if some manufacturability problems in the assembling of the camera lens can be solved and the variation problems after assembling can be improved, the final performance of the product can be better enhanced.

The patentee proposed an optical lens assembly solution, which changed the singularity of previous monolithic optical lens assembly structures. The split optical lens assembly is limited by the characteristics of split assembly. The structural strength and reliability of the split optical lens assembly may be more fragile than the monolithic optical lens assembly. How to improve the structural strength of the optical lens assembly is one of the important problems that need to be solved in the industry to achieve large-scale production of optical lens assemblies. Further, if the optical lens assembly adopts the structure of upper and lower lens-subassemblies, then how to increase the bonding strength of the upper and lower lens-subassemblies is one of the important directions to improve the structural strength of the optical lens assembly. The structure of the upper and lower lens-subassemblies is changed to achieve better reliability of the optical lens assembly, and the structure of the upper and lower lens-subassemblies is also changed to make the active alignment process smoother. In the industry, enhancing the structural strength of optical lens assemblies is an urgent breakthrough for technical personnel in the art. The higher the structural strength of the optical lens assembly, the more diversified the structure of the optical lens assembly is.

In the prior art, technical personnel in the industry often believe that improving the assembly efficiency of optical lens assemblies mainly relies on enhancing active alignment algorithms to improve efficiency. In fact, on the one hand, the improvement of the assembly efficiency of the optical lens assembly relies on algorithm optimization, and on the other hand, if the structure of the optical lens assembly can be improved to achieve simpler assembly steps, the improvement in the structure can also improve the production efficiency of active alignment. In other words, if the structure of the optical lens assembly can adapt to more standardized assembly steps, the assembly steps can be optimized with the improved structure of the optical lens assembly, and the split structure and assembly steps can work together to greatly improve the efficiency of active alignment of the lens assembly.

In summary, from the perspective of the technical field of optical lens assemblies, changes in the structure of optical lens assemblies need to consider more complex factors. Changes in the structure of optical lens assemblies are often closely related to active alignment methods. Therefore, the improvement effect of the structure of optical lens assemblies is often different from the improvement effect of the monolithic lens assemblies. The technical effect achieved by the improvement of the optical lens assembly requires considering the structure of the optical lens assembly and the assembly method of active alignment together to achieve the overall effect.

### SUMMARY

The present application is to provide an optical lens assembly, in which a relatively flat installation reference plane is obtained when a second lens element ceiling surface is roughly flush with a second lens barrel ceiling surface, so that when a first lens element is actively aligned, the adjusting action is more accurate, and the efficiency of active alignment assembly is higher.

An embodiment of the present application is to provide an optical lens assembly, comprising: a first lens element, the first lens element comprising a first structural portion and a first optical portion, and the first structural portion extending outwardly from the first optical portion; and a second lens component, the second lens component comprising a second lens element and a second lens barrel, and the second lens element being mounted in the second lens barrel, wherein the second lens element is bonded to the second lens barrel by means of adhesive provided on an outer side of the second lens element, and the first lens element is mounted on the second lens component by means of the first structural portion, so that when the first lens element is actively aligned, the adjusting action is more accurate, and the efficiency of active alignment assembly is higher.

An embodiment of the present application is to provide an optical lens assembly, wherein the second lens element, at a structural region thereof, has a second lens element ceiling surface close to an object side, the second lens barrel has a second lens barrel ceiling surface, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range, so that when the first lens element is actively aligned, the adjusting action is more accurate, and the efficiency of active alignment assembly is higher.

An embodiment of the present application is to provide an optical lens assembly, which optimizes the bonding structure of the optical lens assembly to make the assembly strength of the optical lens assembly higher.

An embodiment of the present application is to provide an optical lens assembly, which optimizes the bonding structure of the optical lens assembly to make the reliability of the optical lens assembly higher.

An embodiment of the present application is to provide an optical lens assembly, which optimizes the installation structure of the optical lens assembly to make the assembly efficiency of the optical lens assembly higher.

An embodiment of the present application is to provide an optical lens assembly, which optimizes the installation structure of the optical lens assembly to make the assembly yield of the optical lens assembly higher.

An embodiment of the present application is to provide an optical lens assembly, comprising a lens barrel having a lens barrel ceiling surface close to an object side, wherein at least one second lens element is accommodated in the lens barrel, the second lens element comprises a second lens element structural portion, the second lens element structural portion has a second lens element ceiling surface close to an object side, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range, making the assembly efficiency of the optical lens assembly higher.

The present application is to provide an optical lens assembly, in which a relatively flat installation reference plane is obtained when a second lens element ceiling surface is roughly flush with a second lens barrel ceiling surface, so that when a first lens element is actively aligned, the adjusting action is more accurate, and the efficiency of active alignment assembly is higher.

An embodiment of the present application is to provide an optical lens assembly, comprising: a first lens element, the first lens element comprising a first structural portion and a first optical portion, and the first structural portion extending outwardly from the first optical portion; and a second lens component, the second lens component comprising a second lens element and a second lens barrel, and the second lens element being mounted in the second lens barrel, wherein the second lens element is bonded to the second lens barrel by means of adhesive provided on an outer side of the second lens element, and the first lens element is mounted on the second lens component by means of the first structural portion, so that when the first lens element is actively aligned, the adjusting action is more accurate, and the efficiency of active alignment assembly is higher.

An embodiment of the present application is to provide an optical lens assembly, wherein the second lens element, at a structural region thereof, has a second lens element ceiling surface close to an object side, the second lens barrel has a second lens barrel ceiling surface, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range, so that when the first lens element is actively aligned, the adjusting action is more accurate, and the efficiency of active alignment assembly is higher.

An embodiment of the present application is to provide an optical lens assembly, which optimizes the bonding structure of the optical lens assembly to make the assembly strength of the optical lens assembly higher.

An embodiment of the present application is to provide an optical lens assembly, which optimizes the bonding structure of the optical lens assembly to make the reliability of the optical lens assembly higher.

An embodiment of the present application is to provide an optical lens assembly, which optimizes the installation structure of the optical lens assembly to make the assembly efficiency of the optical lens assembly higher.

An embodiment of the present application is to provide an optical lens assembly, which optimizes the installation structure of the optical lens assembly to make the assembly yield of the optical lens assembly higher.

An embodiment of the present application is to provide an optical lens assembly, comprising a lens barrel having a lens barrel ceiling surface close to an object side, wherein at least one second lens element is accommodated in the lens barrel, the second lens element comprises a second lens element structural portion, the second lens element structural portion has a second lens element ceiling surface close to an object side, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range, making the assembly efficiency of the optical lens assembly higher.

Other embodiments and features will also be expounded in detail in the following description, and those skilled in the art will understand, after reviewing the specification, or learn, through the practice of the disclosed subject matter, these embodiments and features. A further understanding of the features and advantages of the present disclosure can be achieved with reference to the remainder of the specification and drawings which constitute a part of the present application.

### BRIEF DESCRIPTION OF THE DRAWINGS

FIG. 1 is a schematic cross-sectional view of an optical lens assembly according to an implementation of the present application;

FIG. 2 is a partial enlarged schematic view of the optical lens assembly according to the implementation of the present application;

FIG. 3A is a schematic cross-sectional view of existing technique A improved according to an embodiment of the present application;

FIG. 3B is a schematic cross-sectional view of existing technique B improved according to an embodiment of the present application;

FIG. 4 is a schematic view of an optical lens assembly structure according to an implementation of the present application when it is subjected to force;

FIG. 5 is a schematic cross-sectional view of the optical lens assembly according to the implementation of the present application when it is subjected to another force;

FIG. 6 is a schematic cross-sectional view of an optical lens assembly according to another implementation of the present application;

FIG. 7 is a schematic perspective view of a second lens element according to an implementation of the present application;

FIG. 8 is a schematic perspective view of an optical lens assembly according to an implementation of the present application; and

FIG. 9 is a schematic cross-sectional view of an optical lens assembly according to another implementation of the present application.

### DETAILED DESCRIPTION

Hereinafter, the present application will be further described in conjunction with specific embodiments. It should be noted that, under the premise of no conflict, various embodiments or technical features described below can be arbitrarily combined to form new embodiments.

The term “comprising” is open ended. As used in the appended claims, this term does not exclude additional structures or steps.

In the description of the present application, it should be noted that orientational words, such as the terms “center”, “lateral”, “longitudinal”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, etc., indicating directions and positional relationships are based on the orientation or positional relationships shown in the relevant figures, which is merely for the convenience of describing the present application and simplifying the description, and does not indicate or imply that the mentioned device or element must have a particular orientation and be constructed and operated in the particular orientation. The aforementioned terms cannot be construed as a limitation of a specific scope of protection of the present application.

It should be noted that the terms “first”, “second”, etc. in the description and claims of the present application are used to distinguish similar objects, and are not necessarily used to describe a specific order or sequence.

The terms “comprising” and “having” and any variations thereof in the specification and claims of present application are intended to cover non-exclusive inclusions. For example, a process, method, system, product or device comprising a series of steps or units is not necessarily limited to those steps or units explicitly listed, but may include other steps or units not explicitly listed or inherent to these processes, methods, products or devices.

It should be noted that as used in the present application, the terms “substantially”, “approximately” and like are used as a term expressing an approximation and not as a term expressing an extent, and are intended to indicate an inherent deviation in a measurement value or calculated value, which will be recognized by those of ordinary skill in the art.

In the description of the present application, it should also be noted that unless otherwise clearly specified and limited, the terms such as “provided”, “mounted”, “coupled” and “connected” should be understood in a broad sense. For example, “connected” may be a fixed connection, a detachable connection or an integral connection; it may be a mechanical connection or an electrical connection; it may be a direct connection, a contact connection or an indirect connection through an intermediate medium; or it may be an internal communication of two elements. For those of ordinary skill in the art, the specific meanings of the aforementioned terms in the present application can be understood according to specific situations.

For the phrase “configured to”, various units, circuits, or other components may be described or recited as “configured to” perform one or more tasks. In such contexts, “configured to” is used to imply a structure (e.g., circuitry) that performs the one or more tasks during operation, by indicating that the unit/circuit/component includes the structure. In addition, “configured to” may include general structures (e.g., general circuitry) manipulated by software and/or firmware to operate in a manner that is capable of performing the one or more tasks to be solved. “Configured to” may also include adjusting a manufacturing process (e.g., a semiconductor fabrication facility) to manufacture a device (e.g., an integrated circuit) suitable for implementing or performing one or more tasks.

The terms used in the description herein are only for describing specific embodiments and are not intended to be restrictive. As used in the specification and the appended claims, the singular forms of “an”, “a” and “the” are intended to also cover the plural forms, unless the context clearly indicates otherwise. It will also be understood that the term “and/or” used herein refers to and covers any and all possible combinations of one or more items in the items listed in association. It will also be understood that the terms “comprising” and/or “including” when used in the specification specify the presence of stated features, integers, steps, operations, elements and/or components, but do not exclude the presence or addition of one or more other features, integers, steps, operations, elements, components and/or combinations thereof.

As used herein, the term “if” may be interpreted to mean “when” or “upon” or “in response to determining” or “in response to detecting,” depending on the context. Similarly, the phrases “if it is determined that . . . ” or “if [a stated condition or event] is detected” may be interpreted to mean “when determining . . . ” or “in response to determining . . . ” or “upon detecting [a stated condition or event]” or “in response to detecting [a stated condition or event],” depending on the context.

### Description of Exemplary Optical Lens Assembly

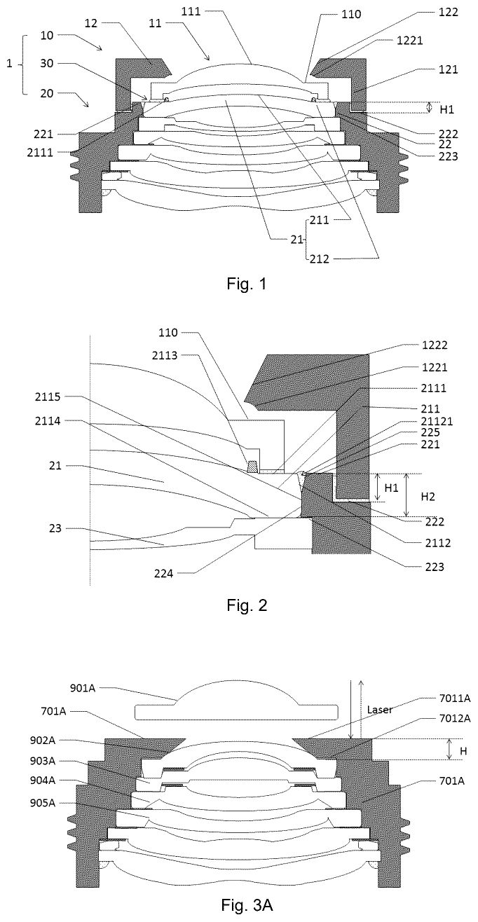

FIG. 1 schematically shows an implementation of an optical lens assembly 1 of the present application. The optical lens assembly 1 of the present application includes a first lens component 10 and a second lens component 20, wherein the first lens component 10 is assembled to the second lens component 20 by means of active alignment. During the active alignment process, the relative position between the first lens component 10 and the second lens component 20 is adjusted, so that the optical lens assembly 1 composed of the first lens component 10 and the second lens component 20 achieves a qualified resolution. After a resolution requirement is met, a connecting component 30 such as adhesive is arranged between the first lens component 10 and the second lens component 20 to fix them, so that the two remain in the relative position determined by the active alignment.

In this embodiment, the first lens component 10 includes a first lens element 11 and a first lens barrel 12, wherein the first lens barrel 12 is provided on the outer side of the first lens element 11, and the first lens barrel 12 is used to protect the first lens element 11 from external impact. In this embodiment, when a clamping mechanism (not shown in the figure) is used to clamp the first lens element 11 and the second lens component 20 for active alignment installation. The clamping mechanism clamps the first lens element 11 to make a more accurate adjustment, and the clamping mechanism clamps the single lens element to enable the efficiency of active alignment to be improved. After the first lens element 11 is mounted on the second lens component 20, the first lens barrel 12 may then be mounted on the second lens component 20, so that the first lens barrel 12 serves to protect the first lens element 11.

The first lens element 11 further includes a first structural portion 110 and a first optical portion 111, wherein the first structural portion 110 integrally extends on the outer side of the first optical portion 111, and the first structural portion 110 serves to support the first lens element 11 against the second lens component 20. The first structural portion 110 extends outwardly from an optical curved surface of the first optical portion 111, so that the first structural portion 110 facilitates mold processing of the first optical portion 111.

An object side surface of the first optical portion 111 is convex, and an image side surface of the first optical portion 111 is concave. This method enables the first lens element 11 to have the function of converging light, thereby reducing the total optical length of the optical lens assembly 1 and further reducing the height of the optical lens assembly 1.

The first lens barrel 12 further includes a first lens barrel positioning portion 121 and a first lens barrel extinction portion 122, wherein the first lens barrel extinction portion 122 is provided above the first lens barrel positioning portion 121, and the first lens barrel extinction portion 122 forms an inclined structural surface 1222 that is inclined close to an optical axis, the inclined structural surface having an opening that gradually decreases from an object side of the optical axis to an image side. The first lens barrel extinction portion 122 can reduce the generation of stray light, and the first lens barrel 12 is positioned and assembled to the second lens component 20 through the first lens barrel positioning portion 121.

The first lens barrel positioning portion 121 is integrally molded with the first lens barrel matting portion 122, and a lower surface of the first lens barrel positioning portion 121 is lower than a lower surface of the first structural portion 110 of the first lens element 11, so that the first lens barrel 12 can be mounted in a manner lower than the first lens element 11, thereby reducing the size of the optical lens assembly 1.

The first lens barrel matting portion 122 further includes a first lens barrel recess 1221 provided on the inclined structural surface 1222 and extending in a planar direction perpendicular to the optical axis, and the first lens barrel recess 1221 is provided as a concave surface dented toward the upper surface of the first lens barrel 12 and corresponding to the convex object side surface of the first optical portion 111. In a preferred solution, the first lens barrel recess 1221 may also be a recessed curved surface facing the upper surface of the first lens barrel 12 and corresponding to the convex object side surface of the first optical portion 111, and the provision of a recess of the curved surface may facilitate molding by a mold tool.

After the clamping mechanism clamps the first lens element 11 to actively align and install it on the second lens component 20, the position of the first lens element 11 relative to the second lens component 20 will change in multiple degrees of freedom due to the alignment assembly. The first lens barrel recess 1221 can avoid collision with the convex object side surface of the first optical portion 111.

The first lens barrel recess 1221 and the upper surface of the first structural portion 110 of the first lens element 11 form a channel, and the channel is in communication with another channel formed by the inner top surface of the first lens barrel 12 and the side wall of the first structural portion 110 of the first lens element 11, thereby forming a channel with a larger outer opening and a smaller inner opening bounded by the first lens barrel recess 1221, so that when the first lens barrel 12 is assembled after being clamped, airflow will be generated when the first lens barrel 12 is assembled downward to the second lens barrel 22, and the flow rate of the airflow produces the effect of a smaller flow rate at a larger opening and a larger flow rate at a smaller opening in the first lens barrel recess 1221. The external dust is blocked by the air pressure difference on the outside of the first lens barrel recess 1221, and it is difficult for the external dust to intrude the gap between the first lens barrel 12 and the first lens element 11 through the first lens barrel recess 1221, thereby reducing the amount of dust remaining in the first lens barrel 12 after the first lens barrel 12 is assembled during active alignment. After the first lens barrel 12 is assembled, the dust in the gap between the first lens barrel 12 and the first lens element 11 is internal dust, which is difficult to remove. Therefore, reducing the intrusion of dust as much as possible when assembling the first lens barrel 12 can improve the production yield of the optical lens assembly 1.

In this embodiment, the second lens component 20 includes a second lens element 21 and a second lens barrel 22, wherein the second lens element 21 is mounted in the second lens barrel 22, and the second lens barrel 22 provides a support and accommodation function for the second lens element 21. The second lens element 21 includes a second structural portion 211 and a second optical portion 212, wherein the second structural portion 211 integrally extends outside the second optical portion 212, the second structural portion 211 serves to support the second lens element 21 in the outer peripheral direction of the second lens barrel 22, and the second structural portion 211 serves to support the second lens element 21 in an optical axis direction of a third lens element 23. The second structural portion 211 extends outwardly from an optical curved surface of the second optical portion 212, so that the second structural portion 211 facilitates the mold processing of the second optical portion 212.

The connecting component 30 further includes first adhesive 31, second adhesive 32, and third adhesive 33, wherein the first adhesive 31 is provided between the first lens element 11 and the second lens element 21, and the first adhesive 31 serves to fix the first lens element 11 and the second lens element 21. The second adhesive 32 is provided between the second lens element 21 and the second lens barrel 22, and the second adhesive 32 serves to fix the second lens element 21 and the second lens barrel 221. The third adhesive 33 is provided between the first lens barrel 12 and the second lens barrel 22, and the third adhesive 33 serves to fix the first lens barrel 12 and the second lens barrel 22. In this embodiment, the first adhesive 31, the second adhesive 32, and the third adhesive 33 are each provided to perform the bonding reinforcement function of the optical lens assembly.

The second structural portion 211 of the second lens element 21 mentioned above is used to provide a structural supporting assembly function for the second lens element 21. In this embodiment, the second lens element structural portion 211 further includes a second lens element ceiling surface 2111, wherein the second lens element ceiling surface 2111 is an upper surface of the second structural portion 211, and the second lens element ceiling surface 2111 is a plane, so that the second lens element ceiling surface 2111 can provide the requirement of a flat surface for assembly.

Referring to FIGS. 1, 2 and 8, in the present application, the second lens barrel 22 includes the second lens barrel ceiling surface 221, and the second lens barrel ceiling surface 221 is the upper surface adjacent to the inner side surface of the second lens barrel 22 on which the first lens element 11 is mounted. In this embodiment, the second lens barrel ceiling surface 221 is the highest upper surface of the second lens barrel 22, wherein the second lens barrel ceiling surface 221 is flush with the second lens element ceiling surface 2111 or the height difference between the second lens element ceiling surface 2111 and the second lens barrel ceiling surface 221 is within 3 μm, so that the second lens barrel ceiling surface 221 can be kept level with the second lens element ceiling surface 2111. As a result, when the clamping mechanism clamps the first lens element 11 for active alignment, the adjusting action is more accurate, and the efficiency of active alignment assembly is higher.

As mentioned above about active alignment, in this embodiment, during active alignment, the posture of the first lens element 11 needs to be adjusted in the clamped state, including adjusting the height of the first lens element 11 relative to the second lens component 20. To meet the requirement of active alignment between lens elements, the optical lens assembly 1 is designed to have high optical sensitivity on the lens component to be clamped and aligned. During active alignment, to meet the requirements of finely adjusting the relative position of the first lens element 11 and the second lens element 21 and being able to quickly affect the peak value or field curvature of the optical system, it is necessary to design the adjacent high-sensitivity lens element group between the first lens component 10 and the second lens component 20. In this embodiment, the first lens element 11 and the second lens element 21 are high-sensitivity lens groups. In the high-sensitivity state, the size of the gap between the first lens element 11 and the second lens element 21 can significantly affect the peak value, field curvature or the like of the optical system. Generally speaking, the high-sensitivity state refers to the relative physical position of the optical lens elements being able to change the performance of the optical system quite significantly with a relative small amount of movement. In the state where the image is relatively blurred, the active alignment algorithm cannot obtain a higher MTF value or SFR value of the image to calculate the position where the image is clear. The efficiency of active alignment will be high only when the lens element group is in a high-sensitivity state. In this embodiment, the actual gap between the first lens element 11 and the second lens element 21 is different from a preset gap (designed gap of the optical system) by 3 μm, which corresponds to the difference between the actual field curvature of the optical system and a preset field curvature (field curvature when the optical system is designed) being within ±9 μm. Alternatively, in this embodiment, the actual gap between the first lens element 11 and the second lens element 21 is different from the preset gap (designed gap) by 3 μm, which corresponds to the actual peak value of the optical system from a preset peak value (peak value when the optical system is designed) within 20%. In addition, a region where the actual gap between the first lens element 11 and the second lens element 21 and the preset gap are different within 3 μm may be referred to as a high sensitive region of the optical lens assembly 1 in this embodiment. The above field curvature and peak value may specifically refer to important fields of view for performance control in the field of camera module manufacturing, such as 0.3 field of view, 0.5 field of view, 0.7 field of view, 0.8 field of view, etc. For camera module manufacturers, only important fields of view need to be measured, and the performance measurement of the camera module can be completed by selecting important test points. To simplify the description, in present application, the range in which the difference value between the actual gap between the first lens element 11 and the second lens element 21 and the preset gap (designed gap) in this embodiment is in the optically high-sensitivity range (in this embodiment, 3 μm is in the optical gap sensitive region of present application) is defined as an optical gap sensitive region. The optical gap sensitive region can also be simply referred to as the gap sensitive region. Through the adaptation of the active alignment algorithm by the inventor, the above field curvature, peak value and gap difference are all examples of expressing that the gap sensitive region is in a high-sensitivity state. To facilitate the explanation of the optical gap sensitive region in this embodiment, it can be understood that the distance between the actual gap between the first lens element 11 and the second lens element 21 and the preset gap in this embodiment enables the actual performance of the corresponding optical system to be as close as possible to the optical performance at the time of design. For example, the gap sensitive region is defined as a region where the difference between the actual gap between the first lens element 11 and the second lens element 21 and the designed gap is within 9 μm of the actual field curvature of the optical system and the preset field curvature, and the gap sensitive region can be considered to be in a high-sensitivity state.

For example, the gap sensitive region is defined as a region where the difference between the actual gap between the first lens element 11 and the second lens element 21 and the designed gap is within 20% of the difference between the actual peak value of the optical system and the preset peak value, and the gap sensitive region can be considered to be in a high-sensitivity state.

For example, the gap sensitive region is defined as a region where the difference between the actual gap between the first lens element 11 and the second lens element 21 and the designed gap is within 3 μm, and the gap sensitive region can be considered to be in a high-sensitivity state.

In this embodiment, the active alignment step generally includes: setting the first lens element 11 and the second lens element 21 to preset positions (initial positions); in the pre-positioning step, according to the position information of the first lens element 11 and its position relative to the second lens component 20, the first lens element 11 is positioned to a pre-positioned height of the second lens component 20; under the condition that the first lens element 11 and the second lens component 20 are at their preset positions, identifying the position when the image is clear according to a mark presented in an image captured by the optical lens assembly 1; and aligning the relative position between the first lens element 11 and the second lens component 20 according to information of the image. In this embodiment, after the pre-positioning of the first lens element 11 and the second lens element 21 is improved, when the gap sensitive region of the two sensitive lens element is in a high-sensitivity state, it can be ensured that the first lens element 11 and the second lens element 21 have a higher resolution when they are in the initial positions, so that the efficiency of active alignment can be improved. In the above description, the difference between the actual gap between the first lens element 11 and the second lens element 21 and the preset gap is such that the actual performance of the corresponding optical system is as close as possible to the designed optical performance. In this embodiment, after the first lens element 11 and the second lens element 21 are pre-positioned, the gap sensitive region of the two sensitive lens elements can be made to be in a high-sensitivity state, which can ensure that the first lens element 11 and the second lens element 21 have a higher resolution when they are in the initial positions, thereby facilitating the subsequent active alignment of the optical lens assembly 1.

In this embodiment, when the first lens element 11 and the second lens element 21 are in a high-sensitivity state, the clamping mechanism of the device needs to first adjust the first lens element 11 to a preset height of the second lens element 21, and the preset height is generally the gap value of the optical system where the first lens element 11 and the second lens element 21 are located in the design state. Only when the actual gap between the first lens element 11 and the second lens element 21 is close to the designed value, the optical lens assembly 1 has a higher resolution and the active alignment adjustment system can work. If the resolution of the optical lens assembly 1 is blurred in the initial position, the active alignment algorithm cannot analyze the MTF value or SFR value in the image information to calculate the adjustment amount for active adjustment.

In other words, if the device cannot know which positions have high resolution from the image, it cannot calculate the adjustment amount according to the MTF value or SFR value. Sometimes it often happens that it is difficult to adjust the blurred state of the image to a clear state through the multi-degree-of-freedom position change of the first lens element 11. Only when the resolution of the optical lens assembly 1 is clear enough in the initial state, the clamping mechanism can make a significant change in the clarity of the image with a small adjustment, so that such an active alignment adjustment system can perform a trend-oriented and targeted physical position correction on the first lens element 11 so as to make the imaging of optical lens assembly 1 clearer.

Referring to FIG. 3A, existing technique A is schematically shown. In the existing technique A, a first lens element 901A is actively aligned and mounted in a clamped state. Before the first lens element 901A is actively aligned, the height of a second lens barrel 701A needs to be measured to obtain height data of an upper surface 7011A of the second lens barrel. In the prior art, laser is often used for measurement. In FIG. 3A, the laser in the laser height measurement (laser altimetry system) is indicated by the name (it may also be indicated by L), the laser is indicated by straight lines, and the arrowed lines indicate the emission and return directions of the laser.

In existing technique A, the height of the upper surface 7011A of the second lens barrel measured by laser cannot directly represent the height of a second lens element 902A. A second lens barrel ceiling surface thickness H (the thickness between the upper surface 7011A of the second lens barrel and the top surface 7012A on the inner wall of the second lens barrel, indicated as H in the figure) will shrink during plastic molding, and the shrinkage factor causes the second lens barrel ceiling surface thickness H to be significantly different from the designed value. Generally, when measuring the second lens barrel ceiling surface thickness H, the shrinkage of the lens barrel itself sometimes causes a dimensional shrinkage rate of 1%-3%. The second lens barrel ceiling surface thickness H is generally 300-500 μm. The shrinkage of the plastic causes a difference in the second lens barrel ceiling surface thickness H, which will cause the second lens barrel ceiling surface thickness H to be different from the designed thickness by 3-15 μm. Although this height can be compensated by the active alignment algorithm, it is obvious that the difference of 3-15 μm greatly exceeds the range of the higher sensitive region between the first lens element 11 and the second lens element 21 in this embodiment (the high sensitive region of the first lens element 11 and the second lens 2 is 3 μm in this embodiment). In the foregoing description, the difference between the actual gap between the first lens element 11 and the second lens element 21 and the designed gap is within 3 μm, which is an optical gap sensitive region. During active alignment, if there is a large deviation in the height of the initial position and it deviates from the sensitive region, an image formed by the optical lens assembly will be blurred. When the image is very blurred, the active alignment algorithm cannot obtain a higher MTF value or SFR value in the image information to make active adjustments. Sometimes, although active alignment can eventually compensate for the lens element after multiple alignments, it takes a lot of time. Therefore, in existing technique A, the efficiency of active alignment is often not high.

On the other hand, in existing technique A, the second lens element 902A is assembled on the top surface 7012A on the inner wall of the second lens barrel through the upper surface of the second lens element 902A, and the third lens element 903A, the fourth lens element 904A, and the fifth lens element 905A are stacked and mounted on the lower side of the second lens element 902A. The third lens element 903A and the fourth lens element 904A will exert assembly pressure when they are assembled. The upper surface 7011A of the second lens barrel needs to offset the contact stress of the assembly of the second lens element 902A, the third lens element 903A, the fourth lens element 904A, and the fifth lens element 905A. Therefore, the second lens barrel ceiling surface H cannot be too thin, and the material properties of the second lens barrel 701A cannot be too soft. In summary, it is difficult to reduce the second lens barrel ceiling surface thickness H on a large scale in existing technique A. The structure of the optical lens assembly in existing technique A will have the aforementioned disadvantages during active alignment, resulting in low efficiency of active alignment.

Referring to FIG. 3B, another existing technique B is schematically shown. In existing technique B, a solution for measuring the height of the upper surface of the second lens element 902B is adopted, although there is no problem of height measurement error caused by shrinkage of the second lens barrel ceiling H in existing technique A. However, in the split lens assembly solution, the lens barrel is relatively rough and easy to be bonded with adhesive. Improving the bonding strength of the optical lens assembly is also a very important improvement route for the optical lens assembly. The improvement of the bonding structure of the optical lens assembly to enhance the reliability of the lens assembly is also an important improvement direction. When adhesive is applied to the second lens barrel 701B, it is necessary to measure the height of the surface where the adhesive is required to be applied, so that the adhesive needle can be inserted to dispense adhesive according to the measured height. As schematically shown in FIG. 3B, for the measurement of laser, the arrowed lines in FIG. 3B indicate the emission and return directions of laser, and two places L1 and L2 in the figure indicate the laser for measuring the lens element height and the laser for measuring the lens barrel height, respectively, and the arrows in the figure represent the direction of the laser.

In existing technique B, there is another problem. When measuring the height of the second lens element 902B, the second lens element 902B itself has a coating or lens element material with high light transmittance. For the laser, the coating of the second lens element 902B will cause the laser reflection signal to decrease, or the laser reflection signal will disappear due to the thin film interference phenomenon caused by the coating of the lens element. The high light transmittance of the second lens element 902B itself will also cause the laser reflection signal to decrease, thereby causing a deviation in the accuracy of laser height measurement. In some cases, the laser will bounce back only after measuring the image side surface of the second lens element 902B, which will cause the laser to produce an error when measuring the height of the surface of the second lens element 902B, thereby causing an error in the height value of the second lens element 902B. When the height data of the second lens element 902B is measured incorrectly, it will affect the position adjustment of the lens element by the mechanism during active alignment. Therefore, in existing technique B, the imaging of the optical lens assembly in the initial state will be relatively blurred, affecting the active alignment efficiency of the optical lens assembly in existing technique B.

Still referring to FIG. 1, the second lens element ceiling surface 2111 is kept level with the second lens barrel ceiling surface 221, or the height discrepancy value between the second lens element ceiling surface 2111 and the second lens barrel ceiling surface 221 is within 3 μm (in the optical gap sensitive region of this embodiment). After a laser measurement structure measures the height of the second lens barrel ceiling surface 221, the clamping mechanism (not shown in the figure) uses the height of the second lens barrel ceiling surface 221 as the height value of the second lens element 21, and directly clamps the first lens element 11 at a preset height of the second lens element 21 through the clamping mechanism. Since the first lens element 11 and the second lens element 21 are within a higher sensitive region of 3 μm (in the optical gap sensitive region of this embodiment), when the first lens element 11 and the second lens element 21 are within a higher sensitive region of 3 μm in the initial position, the optical lens assembly can have a higher resolution, so that the efficiency of active alignment can be improved.

In this embodiment, the second lens barrel ceiling surface thickness H1 is defined by the thickness difference between the second lens barrel ceiling surface 221 and the second lens barrel second top surface 222, which is denoted as H1 in FIG. 2. In this embodiment, the second lens barrel ceiling surface thickness H1 will also be affected by material shrinkage, but the second lens element 21 is mounted on the third lens element 23 through the lower surface of the second lens element 21, and the second lens barrel ceiling surface 221 does not serve to support the second lens element 21. Therefore, the second lens barrel ceiling surface thickness H1 can be reduced in this embodiment, so as to ensure that the second lens barrel ceiling surface 221 is flush with the second lens element ceiling surface 2111 as much as possible. During the process of molding by a mold tool, the height between two step difference surfaces close to each other on the product is the basis of shrinkage during the plastic molding process. Therefore, the larger the step difference height, the larger the basis of product shrinkage, and the greater the size impact of product shrinkage. In this embodiment, the step difference surface adjacent to the second lens barrel ceiling surface 221 includes a second lens barrel second top surface 222 and a second lens barrel inner top surface 223. As can be seen from the figure, the second lens barrel ceiling surface 221 is obviously closer to the second lens barrel second top surface 222. Therefore, in this embodiment, the second lens barrel ceiling surface thickness H1 can have a smaller thickness relative to existing technique A or existing technique B. Although the second lens barrel 22 is still molded from plastic material, the second lens barrel 22 will still be affected by shrinkage during molding, but the second lens barrel ceiling surface thickness H1, on the basis of reduction, can reduce the impact of molding shrinkage.

In this embodiment, the ratio of the second lens barrel ceiling surface thickness H1 to the second lens barrel inner surface thickness H2 (namely the height between the second lens barrel ceiling surface 221 and the second lens barrel inner top surface 223, denoted as H2 in the figure) is ≤2/3 (H1/H2 is less than or equal to 2/3). In the prior art, the second lens barrel inner surface thickness H2 is roughly equivalent to the height of the second lens structure 211, and the second lens barrel inner surface thickness H2 has a height of about 100-200 μm. When the ratio of the second lens barrel ceiling surface thickness H1 to the second lens barrel inner surface thickness H2 is ≤2/3, the thickness of the part of the second lens barrel 22 supported by the third lens element 23 can be ensured, thereby ensuring the structural strength of the second lens barrel 22.

In this embodiment, the data of the height measurement of the second lens barrel 221 is directly used as the height data of the second lens element 21, which can simplify the steps of active alignment assembling method and improve the efficiency of active alignment assembly.

In this embodiment, the second lens barrel ceiling surface thickness H1 is 50-100 μm, and according to the shrinkage rate of 1%-3% of plastic, the shrinkage error of the second lens barrel ceiling surface thickness is within 0.5-3 μm. Due to the special lens element material, according to the manufacturer's experience, the shrinkage rate of the lens element material is ≤0.5%. Therefore, the shrinkage error of the second lens barrel inner surface thickness H2 is within 0.5-1 μm, and the height difference between the ceiling surface thickness H1 of the second lens barrel and the height H2 of the second lens element after tolerance superposition is ≤2.5 μm (because the lens element and the lens barrel are both shrinking and their shapes vary in the same direction, so the two are subtracted). If the size variation of the actual product will be roughly distributed within 2 μm according to the normal distribution, because the size variation of the actual product of present application mostly meets the requirement of the gap sensitive region in this embodiment, the assembly yield of the optical lens assembly 1 can be improved in batches. In addition, those skilled in the art may also modify the mold and the insert to further reduce the error of size shrinkage, thereby improving the assembly yield of the optical lens assembly 1.

In this embodiment, the size error value between the first lens element 11 and the second lens element 21 is within the optical gap sensitive region (defined in the foregoing description). When the ratio of the top surface thickness H1 of the second lens barrel to the height H2 of the second lens element is ≤2/3, the gap between the first lens element 11 and the second lens element 21 caused by the manufacturing error is often smaller than the optical gap sensitive region (within 3 μm in this embodiment). Therefore, from the requirement that the first lens element 11 and the second lens element 21 are in the high sensitive region for active alignment, the height of the second lens barrel ceiling surface 221 can be used as the height of the second lens element ceiling surface 2111. When the second lens element 21 is actively aligned, and the clamping mechanism pre-positions the first lens element 11, the initial optical performance of the optical lens assembly 1 is better, so that the assembly efficiency of active alignment can be improved.

Still referring to FIG. 2, in this embodiment, the lower surface 2114 of the second lens element is supported on the upper surface of the third lens element 23, and the second structural portion includes a second lens element bevelled surface 2112 and a second lens element side wall 2115, wherein the second lens element bevelled surface 2112 is provided between the second lens element upper surface 2111 and the second lens element side wall 2115, the second lens element bevelled surface 2112 serves to transitionally connect the second lens element upper surface 2111 and the second lens element side wall 2115, and the second lens element bevelled surface 2112 also serves to facilitate demolding of the second lens element 21. The second lens element side wall 2115 is on the outer side wall of the second lens element 21, the second lens element side wall 2115 represents substantially a straight edge, and the second lens element side wall 2115 can serve to vertically assemble the second lens element 21 into the second lens barrel 22.

In this embodiment, the second lens barrel 22 further includes a second lens barrel inner wall 224 and a second lens barrel bevelled surface 225, wherein the second lens barrel bevelled surface 225 is provided between the second lens barrel ceiling surface 221 and the second lens barrel inner wall 224, and the second lens barrel bevelled surface 225 serves to transitionally connect the second lens barrel ceiling surface 221 and the second lens barrel inner wall 224. The second lens barrel inner wall 224 represents substantially a straight edge, and the second lens barrel inner wall 224 can serve to support the second lens element 21.

Still referring to FIG. 2, the second lens element 21 abuts against the third lens element 23 through the second lens element lower surface 2114. When the second lens element 21 is mounted on the second lens barrel 22, the second lens element bevelled surface 2112 and the second lens barrel bevelled surface 225 form a first recess 21121 whose opening width decreases in a direction from the first lens element 11 toward the second lens element 21, wherein the second adhesive 32 is provided in the first recess 21121. Since the second adhesive 32 is provided in the first recess 21121, the upper surface of the second adhesive 32 is slightly higher than the second lens barrel ceiling surface 221, and the upper surface of the second adhesive is slightly higher than the second lens element ceiling surface 2111, so that the second adhesive 32 can fully come into contact with the second lens element bevelled surface 2112 and the second lens barrel bevelled surface 225, thereby improving the bonding strength of the second adhesive 32 and improving the reliability of the optical lens assembly 1.

As described in the foregoing part, in this embodiment, the height measurement data of the second lens barrel 22 can be used as the height data for pre-positioning the second lens element 21 in the optical system. For those skilled in the art, the average value of the height error between the upper surface of the second lens element 21 and the second lens barrel ceiling surface 221 is within 3 μm for the height of the adhesive needle insertion, and the height difference within 3 μm is within the error range of the needle insertion of the adhesive syringe. The height measurement data of the second lens barrel 22 can also be used as the height data when the adhesive is applied on the second lens element 21. In this embodiment, only measuring the height data of the upper surface of the second lens element 21 can meet the requirements of height measurement of multiple surfaces, thereby improving the active alignment efficiency of the optical lens assembly 1.

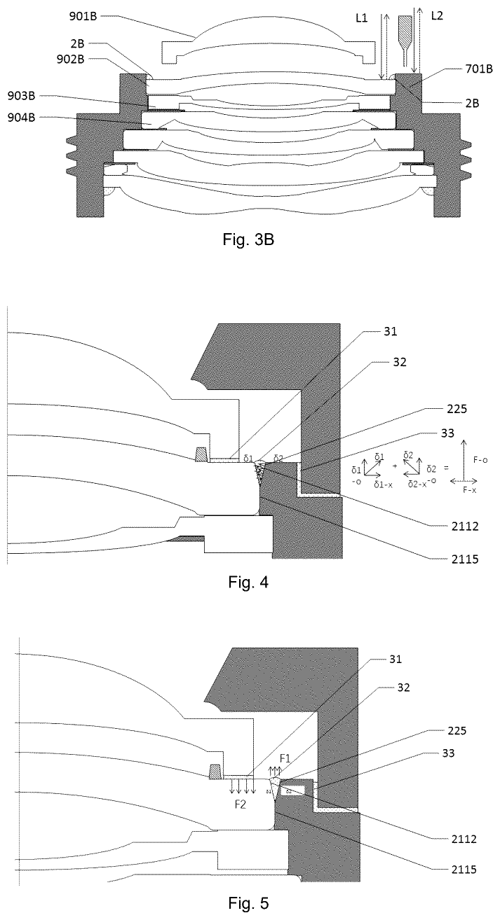

In the present application, FIG. 4 schematically shows an enlarged view of a partial structure of an optical lens assembly according to an embodiment of the present application, wherein the second lens element bevelled surface 2112 and the second lens barrel bevelled surface 225 are symmetrical with the second lens element side wall 2115 as an axis of symmetry. In this embodiment, when the second lens element ceiling surface 2111 and the second lens barrel ceiling surface 221 are kept almost flush, the second lens element bevelled surface 2112 and the second lens barrel bevelled surface 225 are symmetrically provided, so that the third adhesive 33 stored in the second lens element bevelled surface 2112 and the second lens barrel bevelled surface 225 is evenly provided relative to an assembly boundary line of the second lens element 21 and the second lens barrel 22, to enhance the bonding strength. The solid adhesive formed after the third adhesive 33 is cured is fixedly connected between the second lens element bevelled surface 2112 and the second lens barrel bevelled surface 225, and the third adhesive 33 after curing can form a stronger bonding strength. From the engineering experience of optical lens assembly manufacturers, when an optical lens assembly is deformed due to external factors (load, temperature change, etc.), the interaction force on both sides of any cross section of the optical lens assembly 1 where the force is applied is referred to as “internal force”. The concentration of internal force, that is, the internal force per unit region, is referred to as “stress”. The stress may be decomposed into components perpendicular to the cross section, referred to as “direct stress” or “normal stress” (represented by the symbol σ). The unit of stress is Pa. For ease of explanation, in this embodiment, δ1 and δ2 in FIG. 4 schematically show directions of the stress on the second lens element bevelled surface 2112 and the second lens barrel bevelled surface 225, respectively. The tangential stress of the adhesive arranged on the second lens element bevelled surface 2112 is perpendicular to the cross section, as shown by δ1, and the tangential stress of the adhesive arranged on the second lens barrel bevelled surface 225 is perpendicular to the cross section, as shown by δ2. Since the force of δ1 is perpendicular to the second lens element bevelled surface 2112, when the optical lens assembly 1 is subjected to an external impact, the second lens element bevelled surface 2112 is subjected to an obliquely upward tensile stress δ1. Similarly, when the optical lens assembly is subjected to an external impact, the second lens element bevelled surface 2112 is subjected to an obliquely upward tensile stress δ2, wherein both the tensile stress δ1 and the tensile stress δ2 can be decomposed into components along the optical axis direction (δ1-o, δ2-o and F-o in the figure) and components perpendicular to the optical axis (δ1-x, δ2-x and F-x). Since the second lens element bevelled surface 2112 and the second lens barrel bevelled surface 225 are symmetrically arranged with the second lens element side wall 2115 as the axis of symmetry, after the tensile stress δ1 and the tensile stress δ2 are combined to form a force F, it can be determined that the force in the optical axis direction is enhanced, and the tensile stress δ1 and the tensile stress δ2 are offset with each other in the direction perpendicular to the optical axis. As shown in the right side of FIG. 4, the combined force of the tensile stress δ1 and the tensile stress δ2 is schematically shown. The force in the direction perpendicular to the optical axis is indicated by F-x, and F-x is schematically shown by a dotted line, indicating that the magnitude and direction of the force F-x are uncertain after the tensile stress δ1 and the tensile stress δ2 are offset with each other, thereby increasing the reliability of the optical lens assembly 1.

Referring to FIG. 5, it can be known that the component F-o of the combined force in the optical axis direction will cause the second lens element 21 to be subjected to an upward force along the optical axis, and the first adhesive 31 provided between the lower surface of the first lens element 11 and the second lens element ceiling surface 2111 will cause the first adhesive 31 to be subjected to an upward pressure. Then, the first adhesive 31 will be squeezed and deformed to resist the component F-o of the combined force in the optical axis direction, and a downward compressive stress F2 will be generated. The compressive stress F2 acts on the second lens element 21 along the optical axis direction, and the compressive stress F2 can cause the second lens element 21 to be subjected to a downward force. The first adhesive 31 provided on the second lens element 21 can be equivalent to forming a confinement ring, and the first adhesive 31 can better hold the second lens element 21. Along the optical axis direction, the first adhesive 31 and the second adhesive 32 overlap, and the stress generated by the first adhesive 31 and the second adhesive 32 will have a region that covers each other, thereby reducing the warping phenomenon caused by the adhesive stress exerting force on the second lens element 21.

The first adhesive 31 can generate stress on the second lens element 21 in a planar manner. The main stress generated by the first adhesive 31 and the second adhesive 32 on the first lens element 11 is all along the direction of the optical axis. The force along the optical axis can be offset by the lens elements supporting each other. Compared with the obliquely oriented adhesive 2B provided between the second lens element 902B and the second lens barrel 701B in existing technique B, the second lens element in this embodiment is better kept bonded by the first adhesive 31 and the second adhesive 32, and the product reliability of the optical lens assembly in this embodiment is higher.

Still referring to FIGS. 2 and 7, in an embodiment of the present application, the second lens element structural portion 211 further includes a second lens element annular body 2113 provided on the upper end of the second lens element 21, wherein the second lens element annular body 2113 is provided on the second lens element upper surface 2111, and the second lens element annular body 2113 is also close to the optical portion 212 of the second lens element, and the second lens element annular body 2113 is specifically a circle of protrusions provided on the upper end of the second lens element 21. During active alignment, a machine device can identify the second lens element annular body 2113 as a feature of the center of a fit circle, and the first adhesive 31 is also provided on the outer side of the second lens element annular body 2113 in a direction away from the optical axis. Since the second lens element annular body 2113 is a circle of protrusions (it can be seen from FIG. 7 that the second lens element annular body 2113 is a circle of protrusions), it can prevent the first adhesive 31 from overflowing inwardly onto the first lens element optical portion 111 and the second lens element optical portion 212, thereby preventing the optical imaging of the optical lens assembly 1 from being affected.

In the present application, as can be easily conceived of by those skilled in the art, the second lens element annular body 2113 may be other forms of equivalent annular bodies. For example, several bumps are provided on the outer side of the second lens element optical portion 212. These bumps are evenly provided on a circle, which can also achieve a similar effect of visually identifying the rotation center. The bumps arranged in a circular ring can also achieve the effect of preventing the adhesive from overflowing inwardly onto the second lens element optical portion 212.

Still referring to FIGS. 2 and 8, the second lens barrel second top surface 222 of the second lens barrel 22 is used to assemble the first lens barrel 12, wherein the second lens barrel second top surface 222 is lower than the second lens barrel ceiling surface 221. After the first lens barrel positioning portion 121 extends into the step of the second lens barrel 22 formed by the second lens barrel second top surface 222, the second lens barrel ceiling surface 221 and the straight edge therebetween, the gap between the second lens barrel positioning portion 121 and the second lens barrel second top surface 222 and the gap between the second lens barrel positioning portion 121 and the second lens barrel outer side wall are provided with the third adhesive 33, wherein after the second lens barrel positioning portion 121 extends into the second lens barrel second top surface 222, the gap formed between the second lens barrel positioning portion 121 and the second lens barrel second top surface 222 is a channel extending in the horizontal direction, a gap formed between the second lens barrel positioning portion 121 and the second lens barrel outer side wall is a channel extending in the vertical direction, and the channel extending in the horizontal direction and the channel extending in the vertical direction are connected to form a roughly “L”-shaped channel. When the third adhesive 33 is provided in the roughly “L”-shaped channel, the adhesive bonding area is larger than that in the horizontal direction. Therefore, the use of this “L”-shaped channel between the first lens barrel 12 and the second lens barrel 22 can increase the bonding strength of assembling the first lens barrel 12 onto the second lens barrel 22.

The active alignment in this embodiment is a process of adjusting the relative position of the first lens element 11 and the second lens element 21 according to the actual imaging result of the optical system. During the active alignment process, a pickup mechanism (such as a clamping mechanism) may move the first lens element 11 in multiple degrees of freedom by clamping the outer side surface of the first lens element 11, thereby adjusting the relative position of the first lens element 11 and the second lens element 21, and then finding a position that can optimize an actual imaging result of the optical system. The actual imaging result here refers to an actual image received and output by a photosensitive chip placed on the image side of the optical lens assembly 1. The photosensitive chip may be a photosensitive chip specifically used for an active alignment process (in this case, the photosensitive chip may be provided in an active alignment device), or may be a photosensitive chip in a photosensitive assembly to be actually assembled (in this case, the photosensitive chip used for active alignment will eventually be assembled with the aligned optical lens assembly to form a camera module). Since the first lens element 11 has manufacturing tolerances during the manufacturing process, there are manufacturing tolerances and assembly tolerances between lens elements in the second lens component 20. After active alignment, the central axis of the first lens element 11 and the central axis of the second lens component 20 may have a non-zero included angle, so that the aforementioned manufacturing tolerances and assembly tolerances can be compensated. In addition, in some implementations, the central axis of the first lens element 11 and the central axis of the second lens element 21 may have a non-zero included angle, so that the aforementioned manufacturing tolerances and assembly tolerances can be compensated.

In this embodiment, during active alignment, it is necessary to adjust the posture of the first lens element 11 in a clamped state, including adjusting the height of the first lens element 11 relative to the second lens element 21 until the optical system has a more proper resolution. Further, the clamping mechanism of the device needs to first adjust the first lens element 11 to a preset height of the second lens element 21. The preset height is generally a designed height of the first lens element 11 and the second lens element 21. At this designed height, the optical lens assembly 1 has a higher resolution. In the initial state of active alignment, the first lens element 11 and the second lens element 21 are required to be at a certain preset height and then be actively aligned. On the other hand, in general, optical height measurement is to measure the height of a lens element or a lens barrel. Since the lens element itself has a coating or high light transmittance, for height measurement with laser (laser altimetry system), the lens element coating will cause a signal of laser reflection to decrease or the laser reflection signal to disappear due to thin film interference. In addition, the high light transmittance of the lens element itself will also cause the laser reflection signal to decrease, thereby causing a deviation in the accuracy of height measurement with laser. In some cases, the laser will not bounce until it measures the image side surface of the lens element, which will cause a large difference between the height distance measured by the laser and the actual height. Undoubtedly, for a clamping mechanism that requires μm-level accuracy, when the height between the first lens element 11 and the second lens element 21 has a large error with the preset height, the resolution of the split lens assembly 1 in the initial state will not be good enough, and the error needs multiple adjustments of the active alignment algorithm to be corrected.

In the present application, the second lens barrel ceiling surface 221 is used as the reference plane for height measurement of the second lens element 21. The second lens barrel ceiling surface 221 and the structural surface of the second lens element 21 are set as a horizontal plane, which can improve the accuracy of the height measurement of the optical lens assembly 1. Therefore, the laser height measuring device can measure the reference plane for height measurement of the second lens barrel 22 to meet the requirement of measuring the height of the second lens element 21. This method can make the optical lens assembly 1 have a higher resolution already in the initial state of active alignment. In the case of higher resolution, the judgment of the peak position is more accurate, so that the measurement of various indicators in the resolution, such as image plane tilt, field curvature, etc., can be more accurate, and the adjustment speed of active alignment can be accelerated, making the speed of active alignment and optical performance more excellent.

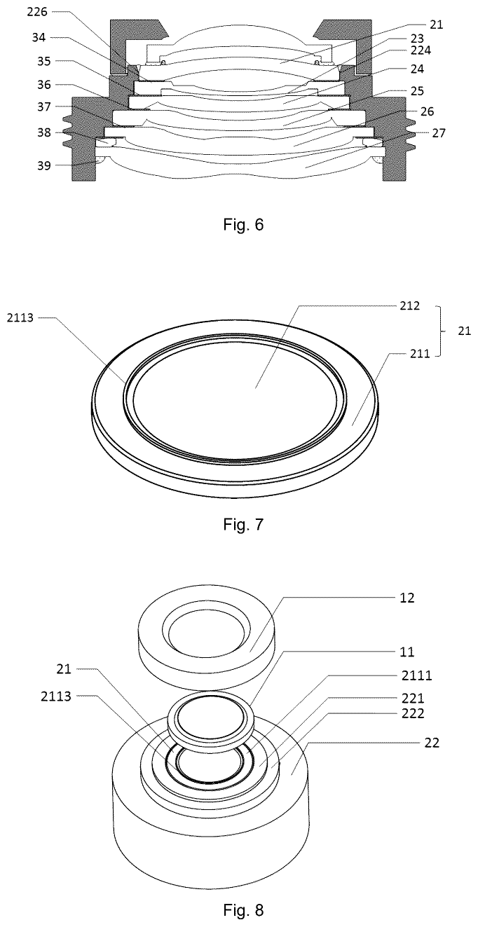

Referring to FIG. 6, in detail, the connecting component 30 further includes a first spacer ring 34, a second spacer ring 35, a third spacer ring 36, a fourth spacer ring 37, a fifth spacer ring 38 and fourth adhesive 39 in order from an object side to an image side. The first spacer ring 34, the second spacer ring 35, the third spacer ring 36, the fourth spacer ring 37 and the fifth spacer ring 38 are assembled in the second lens component 20. The second lens element 21, the first spacer ring 34, the third lens element 23, the second spacer ring 35, a fourth lens element 24, the third spacer ring 36, a fifth lens element 25, the fourth spacer ring 37, a sixth lens element 26, the fifth spacer ring 38, a seventh lens element 27 and a fixing ring 39 are included in order from the object side to the image side, wherein the fixing ring 39 is fixed on the image side of the seventh lens element 27. This way of providing a spacer ring between every two lens element can be used to reduce the internal stray light generated by reflection or refraction in the optical lens assembly.

The inner wall 224 of the second lens barrel forms a first nesting portion 226 around the second lens element 21, wherein in this embodiment, when the outer diameter of the second lens element 21 is r1, and the inner diameter of the first nesting portion 226 is R1, the inner diameter R1 of the first nesting portion is greater than the outer diameter r1 of the second lens element 21, and the inner diameter R1 of the first nesting portion 226 is less than the outer diameter r1 of the second lens element 21 plus 5 μm. This method enables the second lens element 21 to be mounted in the first nesting portion 226 with an appropriate gap, so that when the second lens element 21 is loaded into the first nesting portion 226, the second lens element 21 can be assembled in the first nesting portion 226 with a relatively tight fit. In addition, within this distance, the outer side surface of the second lens element 21 can be considered that the second lens element bevelled surface 2112 and the second lens barrel bevelled surface 225 are symmetrical with the second lens element side wall 2115 as the axis of symmetry, thereby increasing the reliability of the assembly of the second lens element 21.

In summary, after refining the main ideas of the present disclosure, it can be obtained that the present application proposes a lens barrel available for assembling a first lens element, having a lens barrel ceiling surface close to the object side, wherein at least one second lens element 21 is accommodated in the lens barrel, the second lens element 21 includes a second structural portion 211, the second lens element structural portion 211 has a second lens element ceiling surface 2111 close to the object side, a height difference between the second lens element ceiling surface 2111 and a lens barrel ceiling surface is within an optical gap sensitive region, and the optical gap sensitive region depends on that a value of deviation of an actual gap between the first lens element and the second lens element from a preset gap in an optical sensitivity range. It can be known by those skilled in the art that when there is no first lens barrel 12 in the present application, the second lens barrel 22 can serve as a lens barrel supporting the first lens element 11, the second lens element 21 and other components, which may also be used as a complete lens assembly with the function of optical imaging, and can also solve at least one of the aforementioned problems. Therefore, the second lens barrel 22 can be interpreted in an expanded manner generally as a lens barrel, and the ceiling surface of the lens barrel can be simply referred to as the second lens barrel ceiling surface 221.

In addition, after refining the main ideas of the present disclosure, it can be obtained that the present application proposes an optical lens assembly, including: a first lens element 11, including: a first structural portion 110 and a first optical portion 111, wherein the first structural portion 110 extends outwardly from the first optical portion 111; and a second lens component 20, including: a second lens element 21 and a second lens barrel 22, wherein the second lens element 21 is mounted in the second lens barrel 22, the second lens element 21 is bonded to the second lens barrel 22 by adhesive provided on the outer side of the second lens element, and the first lens element 11 is mounted on the second lens component through the first structural portion 110. It is mainly expounded in this technical solution that the first lens element 11 in the present application is assembled to the second lens component 20, and the second lens element 21 is bonded to the second lens barrel 22 by adhesive provided on the outer side of the second lens, to achieve the effect of obtaining a flush surface. It can be obtained by those skilled in the art that due to the structure of the common base surface of the second lens element 21 and the second lens barrel 22 in the present application, a relatively flush installation reference plane is obtained so that the first lens element 11 can be mounted in a more accurate manner. Therefore, whether the first lens element 11 is actively aligned for installation or the first lens element 11 is directly attached for installation, the first lens element 11 can be mounted with high accuracy, and the effect of high-accuracy assembly of the first lens element can be achieved. In addition, after refining the main ideas of the present disclosure, it can be obtained that the first lens element 11 and the second lens element 21 in the present application are actively aligned lens groups. It can be broadly interpreted that the first lens element 11 is equivalent to an adjustable lens element or an adjustable lens group in the split lens assembly of split alignment, and the second lens element 21 is equivalent to a fixed lens element or a fixed lens group in the split lens assembly of split alignment, wherein the adjustable lens element is aligned and assembled relative to the fixed lens element, or the adjustable lens group is aligned and assembled relative to the fixed lens group. Without limiting the number of first lens element(s) 11 and the number of second lens element(s) 21, it can be considered that two lens elements to be aligned and assembled by the split lens assembly of active alignment are equivalent to the first lens element 11 and the second lens element 21 of the present application.

The present application proposes an optical lens assembly 1, including a first lens component 10 and a second lens component 20, wherein the second lens component 20 includes a second lens element 21 and a second lens barrel 22, a height discrepancy value between a ceiling surface 221 of the second lens barrel and a ceiling surface 2111 of the second lens element is within an optical gap sensitive region of the first lens component 10 and the second lens element 21, and the first lens component 10 is assembled on the ceiling surface 2111 of the second lens element through active alignment. Here, the ceiling surface of the second lens barrel and the ceiling surface of the second lens element refer to the second lens barrel ceiling surface 221 and the second lens element ceiling surface 2111, respectively.

The first lens component 10 further includes a first lens element 11 and a first lens barrel 12, wherein the structural portion of the first lens element 11 is clamped by a clamping mechanism and then assembled onto the second lens element ceiling surface 2111 after active alignment.

The present application further proposes a camera module equipped with the optical lens assembly as described above.

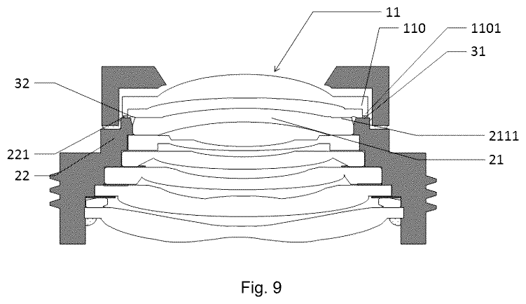

FIG. 9 schematically shows another embodiment of the optical lens assembly of the present application. When the second lens element ceiling surface 2111 and the second lens barrel ceiling surface 221 are roughly flush based on the present application, the first lens element 11 can be mounted on the second lens element 21 or the second lens barrel 22 as required. In the embodiment of FIG. 9, the first lens element 11 is mounted on the second lens barrel ceiling surface 221 through the downward extension portion 1101 of the first structural portion 110. When the first lens element 11 is assembled on the second lens barrel 22 on the outer side of the second lens element 21, the outer diameter of the first lens element 11 can be increased, so that the available clear aperture of the optical lens assembly becomes larger. Often, when the available clear aperture of the optical lens assembly is increased, a larger aperture of camera can be achieved, thereby achieving a better imaging effect. It is worth noting that since the first adhesive 31 is provided between the first lens element 11 and the second lens barrel 22, the first adhesive 31 is provided on the outer side of the second lens barrel ceiling surface 221, so that the first adhesive 31 can be away from the second adhesive 32 to avoid collision with the first lens element 11 after the second adhesive 32 is cured.

The downward extension portion 1101 may extend partially toward the image side to form a protrusion, thereby ensuring that the structural portion and the optical portion of the first lens element 11 have substantially uniform thickness, making injection molding simpler.

The basic principles, main features and advantages of the present disclosure have been described above. It should be understood by those skilled in the industry that the present disclosure is not limited to the foregoing embodiments; the foregoing embodiments and the specification only describe the principles of the present disclosure; without departing from the spirit and scope of the present disclosure, the present disclosure will have various changes and improvements; and these changes and improvements all fall within the scope of protection claimed by the present disclosure. The scope of protection claimed by the present disclosure is defined by the appended claims and their equivalents.

1.-23. (canceled)

24. An optical lens assembly, comprising:
a first lens element comprising a first structural portion and a first optical portion, the first structural portion extending outwardly from the first optical portion; and
a second lens component comprising a second lens element and a second lens barrel, the second lens element being mounted in the second lens barrel, wherein the second lens element is bonded to the second lens barrel by means of adhesive provided on an outer side of the second lens element, and the first lens element is mounted on the second lens component by means of the first structural portion.

25. The optical lens assembly according to claim 24, wherein the first lens element is mounted on the second lens element or on the second lens barrel by means of the first structural portion.

26. The optical lens assembly according to claim 25, wherein the second lens element comprises a second structural portion, which has a second lens element ceiling surface close to an object side, the second lens barrel has a second lens barrel ceiling surface, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range.

27. The optical lens assembly according to claim 26, wherein the second structural portion comprises a second lens element bevelled surface and a second lens element side wall, the second lens element bevelled surface is provided between an upper surface of the second lens element and the second lens element side wall, the second lens element side wall represents a straight edge, the second lens element abuts against a third lens element by means of a lower surface of the second lens element, the second lens element bevelled surface and a second lens barrel bevelled surface form a first recess, which changes from large to small in opening width in a direction from the first lens element toward the second lens element, and a second adhesive is provided in the first recess.

28. The optical lens assembly according to claim 27, wherein the optical lens assembly further comprises a first lens barrel, the first lens barrel is provided on an outer side of the first lens element, the first lens barrel is further provided with a first lens barrel recess, and the first lens barrel recess is provided as a concave surface corresponding to the first optical portion and dented toward an upper surface of the first lens barrel.

29. The optical lens assembly according to claim 28, wherein the first lens barrel recess and an upper surface of the first structural portion of the first lens element form a channel, which is in communication with another channel formed by an inner top surface of the first lens barrel and a side wall of the first structural portion of the first lens element, to form a communicating channel, which has a larger outer opening extending outwards from the first lens barrel recess and a smaller inner opening extending inwards from the first lens barrel recess.

30. The optical lens assembly according to claim 29, wherein the second lens barrel ceiling surface is the highest top surface of the second lens barrel; the second lens element ceiling surface is an upper surface of the second structural portion; a height difference between the second lens barrel ceiling surface and the second lens element ceiling surface is within the optical gap sensitive region; the second lens barrel has a second lens barrel second top surface adjacent to the second lens barrel ceiling surface and a second lens barrel inner top surface; a second lens barrel ceiling surface thickness H1 is defined as a height difference between the second lens barrel ceiling surface and the second lens barrel second top surface; a second lens barrel inner surface thickness H2 is defined as a height difference between the second lens barrel ceiling surface and the second lens barrel inner top surface; and a ratio of the second lens barrel ceiling surface thickness H1 to the second lens barrel inner surface thickness H2 is less than or equal to 2/3.

31. The optical lens assembly according to claim 30, wherein the second lens barrel comprises a second lens barrel inner wall and a second lens barrel bevelled surface, the second lens barrel bevelled surface is provided between the second lens barrel ceiling surface and the second lens barrel inner wall, and the second lens barrel inner wall represents a straight edge.

32. The optical lens assembly according to claim 31, wherein the second lens barrel ceiling surface is configured as a reference plane for height measurement of the second lens element.

33. A camera module, comprising the optical lens assembly according to claim 24.

34. An optical lens assembly, which is available for assembling a first lens element, comprising:
a second lens barrel having a second lens barrel ceiling surface close to an object side, wherein at least one second lens element is accommodated in the second lens barrel, the second lens element comprises a second structural portion, the second structural portion has a second lens element ceiling surface close to an object side, a height discrepancy value between the second lens element ceiling surface and the second lens barrel ceiling surface is within an optical gap sensitive region, and the optical gap sensitive region depends on that a value of deviation of an actual gap between the first lens element and the second lens element from a preset gap is in an optical sensitivity range.

35. The optical lens assembly according to claim 34, wherein the gap sensitive region is defined as a region where a deviation of the actual gap between the first lens element and the second lens element from a designed gap corresponds to a difference within 9 μm of an actual field curvature of an optical system from a preset field curvature; or
the gap sensitive region is defined as a region where a deviation of the actual gap between the first lens element and the second lens element from a designed gap corresponds to a deviation range of 20% between an actual peak value of an optical system and a preset peak value; or
the gap sensitive region is defined as a region where a deviation of the actual gap between the first lens element and the second lens element from a designed gap is within 3 μm.

36. The optical lens assembly according to claim 34, wherein the second lens element comprises the second structural portion and a second optical portion, the second structural portion integrally extends outside the second optical portion, and the second structural portion extends outwardly from an optical curved surface of the second optical portion.

37. The optical lens assembly according to claim 35, wherein the second lens barrel ceiling surface is the highest top surface of the second lens barrel, the second lens element ceiling surface is an upper surface of the second structural portion, and the height difference between the second lens barrel ceiling surface and the second lens element ceiling surface is within the optical gap sensitive region.

38. The optical lens assembly according to claim 37, wherein the second lens barrel ceiling surface is configured as a reference plane for height measurement of the second lens element.

39. The optical lens assembly according to claim 38, wherein the second lens barrel comprises a second lens barrel inner wall and a second lens barrel bevelled surface, the second lens barrel bevelled surface is provided between the second lens barrel ceiling surface and the second lens barrel inner wall, and the second lens barrel inner wall represents a straight edge.

40. The optical lens assembly according to claim 39, wherein the second structural portion comprises a second lens element bevelled surface and a second lens element side wall, the second lens element bevelled surface is provided between an upper surface of the second lens element and the second lens element side wall, the second lens element side wall represents a straight edge, the second lens element abuts against a third lens element by means of a lower surface of the second lens element, the second lens element bevelled surface and a second lens barrel bevelled surface form a first recess, which changes from large to small in opening width in a direction from the first lens element toward the second lens element, and a second adhesive is provided in the first recess.

41. The optical lens assembly according to claim 40, wherein an upper surface of the second adhesive is higher than the second lens barrel ceiling surface, and the upper surface of the second adhesive is higher than the second lens element ceiling surface.

42. The optical lens assembly according to claim 41, wherein the second lens barrel comprises a second lens barrel second top surface adjacent to the second lens barrel ceiling surface and a second lens barrel inner top surface, a second lens barrel ceiling surface thickness H1 is defined as a height difference between the second lens barrel ceiling surface and the second lens barrel second top surface, a second lens barrel inner surface thickness H2 is defined as a height difference between the second lens barrel ceiling surface and the second lens barrel inner top surface, and a ratio of the second lens barrel ceiling surface thickness H1 to the second lens barrel inner surface thickness H2 is less than or equal to 2/3.

43. A camera module, comprising the optical lens assembly according to claim 34.
